(19) United States
(12) Patent Application Publication
(10) Pub. No.: US 2003/0023687 A1
(43) Pub. Date: Jan. 30, 2003

(54) System, method and storage medium for generating a commission link

(76) Inventor: Peter V. Wolfe, Reading, MA (US)

Correspondence Address: Deborah B. Crenshaw, Esq., 55 Griffin Road South, Bloomfield, CT, 06002, US

(21) Appl. No.: 09/839,194

(22) Filed: Apr. 19, 2001

(51) Int. Cl. G06F 15/16

(52) U.S. Cl. 709/206; 709/227; 705/14

(57) ABSTRACT

An exemplary embodiment is a system, method and storage medium for generating a commission link. The system includes an affiliate host system for presenting a user with a link to a first location having a corresponding coded link to a second location, receiving an input based on the user's selection of the link to the first location, connecting the user to the second location, connecting the user to the first location after a selected period at the second location and receiving a commission based on connecting the user to the second location. A network is coupled to the affiliate host system, and an affiliate database is couple to the affiliate host system.

### BACKGROUND

The invention relates generally to electronic commerce, and more specifically, to a system, method and storage medium for generating a commission link.

As online (e.g., Internet and the World Wide Web) marketing becomes increasingly competitive, merchants need an effective solution for attracting customers. One solution involves awarding a commission to Web site operators for providing a link to a merchant's Web site. For example, a visitor to a Web site sees a merchant ad banner or text link, clicks on the ad banner or text link and purchases an item or service from the merchant's Web site. As a result, the Web site operator gets a commission from the sale. Obviously, tracking and recording such purchases (so that the Web site owner receives the corresponding commission) is needed. However, implementation is logistically complex.

One technique for implementation is to create an affiliate program in which Web site operators apply for membership. In general, an affiliate program is a commission tool used by an online merchant to pay Web site operators for referring customers to the merchant Web site. With an affiliate program, a Web site operator usually applies to a merchant, is approved (becoming an “affiliate” of the merchant) and is given an identity code to use in links that direct a visitor to the merchant's Web site. Some online merchants have their own affiliate programs, however, the affiliate program function may also be provided by a third-party. Affiliate networks are networks developed by third-parties for providing an affiliate program function to merchants on a contract basis. One service provided by affiliate networks is the tracking and reporting of how much commission an affiliate has earned. Affiliate networks may also remind online merchants to pay the affiliate, along with keeping track of the payments.

Affiliate networks use various means to implement the affiliate programs, but they use their own Web servers to handle the bulk of the tracking and reporting. Such affiliate programs do well in a traditional shopping situation: where a person clicks on a link, finds a product, and purchases it immediately. However, such affiliate programs are ineffective in situations such as a gift registry, where a Web site visitor clicking on a merchant link is not the same person making the actual purchase. Also, such affiliate programs will not work if the actual purchase occurs days or months after the product is selected. Further, such affiliate programs are not effective in situations where direct links to a particular product are desired, but not provided by the affiliate program.

Therefore, there remains a need for a system, method and storage medium for generating a commission link that resolves these problems.

### SUMMARY

An exemplary embodiment is a system, method and storage medium for generating a commission link. The system includes an affiliate host system for presenting a user with a link to a first location having a corresponding coded link to a second location, receiving an input based on the user's selection of the link to the first location, connecting the user to the second location, connecting the user to the first location after a selected period at the second location and receiving a commission based on connecting the user to the second location. A network is coupled to the affiliate host system, and an affiliate database is couple to the affiliate host system.

### BRIEF DESCRIPTION OF THE DRAWINGS

Referring now to the drawings wherein like elements are numbered alike in several FIGURES:

FIG. 1 is a block diagram of an exemplary system for generating a commission in a merchant-administered affiliate program;

FIG. 2 is an exemplary browser window in an exemplary system for generating a commission in a merchant-administered affiliate program;

FIG. 3 is a block diagram of an exemplary system for generating a commission in a third-party-administered affiliate program;

FIG. 4 is an exemplary browser window in an exemplary system for generating a commission in a third-party-administered affiliate program;

FIG. 5 is a block diagram of an exemplary system for generating a commission in a third-party-administered affiliate program in another embodiment;

FIG. 6 is an exemplary browser window in an exemplary system for generating a commission in a third-party-administered affiliate program in another embodiment;

FIG. 7 is an exemplary browser window illustrating the structure of a horizontally-divided frameset; and

FIG. 8 is an exemplary browser window illustrating the use of a horizontally-divided frameset in a purchasing situation.

### DETAILED DESCRIPTION

As previously discussed, in general, an affiliate program is a commission tool used by an online merchant to pay Web site operators for referring customers to the merchant Web site, and where the customer purchases a product or performs some other desired activity. In an affiliate program offered by a merchant, a Web site operator usually applies to the merchant, is approved (becoming an “affiliate” of the merchant), and is given an identity code to use in Uniform Resource Locator (URL) links placed on the Web site that point to the merchant's URL. The following is an example of a merchant's home page URL, along with an exemplary identity code that an affiliate may use as its link to the merchant's home page:

Merchant's Home Page URL:

http://www.merchant.com

Merchant's Home Page Affiliate Link with identity code of “swagbagcom”:

http://www.merchant.com/exec/obidos/redirect-home/swagbagcom

The merchant's Web servers look for these identity codes when a visitor (consumer) enters the merchant Web site. If the identity codes are present, the merchant identifies the affiliate (Web site operator) responsible for referring the consumer and tracks the consumer's actions during the session. Many affiliate programs pay affiliates a percentage of sales generated from consumers referred by the affiliate. Other programs pay commissions based on a consumer joining a program, or they pay a set fee for each consumer referred, regardless of what that consumer does once at the merchant's Web site. In the above example, the affiliate's identity code “swagbagcom” is linked to the affiliate's account, and a percentage of any purchases made by a consumer during the session initiated by clicking on the above link is credited to the corresponding affiliate account.

As previously discussed, affiliate programs may also be implemented by third-parties via an affiliate network under contract with merchants to provide such a service. Affiliate networks implement their programs differently than a merchant implements a merchant-based affiliate program. Instead of providing the affiliate with a simple identity code to insert into a link URL, an affiliate network provides an entire URL that directs the consumer to the affiliate network's site, rather than to the merchant's site. The following is an example of a merchant home page URL and the associated affiliate network's home page URL:

Merchant's Home Page URL:

http://www.merchant.com

Affiliate Network's Home Page URL for merchant.com:

<a href=“http://www.affiliate-network.com/track/track.dll?AID=546295&PID=236266&URL=http%3A%2 F%2Fwww%2Emerchant%2Ecom”>Merchant.com</a><img src=“http://www.affiliate-network.com/banners/tracker.exe?AID=546295&PID=236266&banner=0.gif”height=1 width=1 border=0>

Note that the affiliate network's linking reference tag (the one after “href=” in the affiliate network's home page link) is a Web site operated by the affiliate network (e.g., affiliate-network.com), rather than the merchant. Thus, when the consumer is linked to the affiliate network's Web site, a tracking process may be triggered. Next, the affiliate network's Web server redirects the consumer to the merchant's Web site. The merchant's Web site continues the tracking process and reports any resulting sales and commissions back to the affiliate network. Once the consumer has been redirected from the affiliate network's Web site to the merchant's Web site, the URL displayed in the consumer's browser corresponds to the merchant's Web site, and not the affiliate network's Web site. In most cases, the consumer is unaware that he or she is first directed to the affiliate network's Web site before going to the merchant's Web site. For example, in the consumer's perspective, he or she visits a Web site, clicks on a link labeled “merchant.com” and is taken directly to the merchant.com site, complete with the merchant.com URL in the browser's address bar.

A variety of ways may be used to accomplish the tracking necessary to generate affiliate commissions. A simple technique includes placing a “cookie” on the consumer's computer, that identifies the referring affiliate, when they visit the affiliate network's server. A cookie is a block of data that a Web server returns to a client system in response to a request from the client system. In other words, cookies are used to identify users, instruct a Web server to send a particular version of a requested Web page to the user, submit account information about the user and the like. A Web server checks for the presence of a cookie whenever a consumer enters a Web site. The contents of the cookie may identify which affiliate to credit for purchases made during the session.

In addition to linking directly to a merchant's home page, there are other ways an affiliate may wish to link to the merchant, including linking to:

An individual item selected from a predetermined list;

Any individual item offered on the merchant's Web site;

A department or category within the merchant's Web site;

A search box; and/or

A dynamically-generated list of products (frequently called an “auto-merchandising link”).

Each merchant determines the types of links to be available to affiliates. Merchants regularly provide links to their home pages, since this is basic for implementing an effective affiliate program. Some merchants provide other types of links, depending on the structure of their merchant Web sites, organization of their products, technological sophistication, and overall attitude towards affiliate programs. These other links may have different formats than a merchant's home page URL link, as illustrated in the example link to a merchant's individual product shown below:

Individual Product URL at merchant.com:

http://www.merchant.com/asp/bookfo.asp?style=text&afl=&LC=7777+29325&cart=100800825

Corresponding Affiliate Network Product Code:

<a href=“http://click.affiliate-network.com/fs-bin/stat?id=G1htY0Jnve0&offerid=7225&type=2&subid=0&url=http%253A// www%252Emerchant%252Ecom/asp/bookinfo%252Easp%253Fstyle%253Dt ext%2526afl%253D%2526LC”>Yorkshire Terriers<IMG border=0alt=icon width=1 height=1 src=“http://ad.affiliate-network.com/fs-bin/show?id=G1htY0Jnve0&bids=7225&type=2&subid=0”></a>

As discussed, in the past, the majority of affiliate programs did not have the ability to link to an individual item offered by a merchant and receive a commission. In some online shopping experiences, such a limitation is not a problem. However, in a situation such as a gift registry, the ability to link to individual products is needed. Usually, an online shopping experience is much like an offline or “brick and mortar” shopping experience. A person visits a merchant, browses through their goods, selects an item, and purchases it. Most affiliate programs work well in this situation, with the affiliate providing the link that causes the person to visit the merchant. As long as the consumer arrives at the merchant's Web site via an affiliate link and does not leave the merchant's Web site before making a purchase, the affiliate gets credit for the sale. Thus, the affiliate may simply provide a link to the merchant's home page, or the merchant may include links to specific products that correspond with the subject matter of the affiliate's Web site (for example, an affiliate with a Web site dedicated to dog owners may select specific books about dogs to feature on its Web site, and provide links to the specific merchant individual product URLs where the books may be purchased).

A gift registry shopping experience is much different from a normal shopping experience in some important ways. To create a gift registry, a person (the “gift registry creator”) visits a merchant, browses through their goods, and makes a list of specific products they would like to receive for some special occasion. Later, a different person (the “gift purchaser”) visits the merchant, finds a specific product listed in the gift registry, and purchases it. An effective gift registry is very specific in describing the items listed. After all, the purpose of a gift registry is to eliminate ambiguity (and duplication).

An online gift registry may include a list of URLs (links) where individual products may be directly linked to, and subsequently purchased. The gift registry creator may create the list manually, or with the help of the online gift registry by recording the merchant's corresponding individual product URL for future viewing (similar to a browser's book marking function). The link seen by the gift registry creator is the merchant's individual product URL as displayed in his or her browser's address line. Subsequently, the gift purchaser may view the list online, and click on a listed product URL. This links the gift purchaser to the merchant's individual product Web site, where the product may then be purchased.

However, the gift registry creator only has access to the regular merchant URLs as displayed in the browser's address line with which to create the gift registry and, therefore, populates the gift registry with these merchant URLs. These merchant URLs are different than the affiliate URLs because they lack the structure and identity codes that are necessary to carry out the affiliate program tracking process. Without an identity code for identifying the affiliate, no commissions would be generated for the affiliate if a purchase is made after clicking one of these links. In other words, subsequently, the gift purchaser would visit the merchant's site and make the purchase via a normal URL (a URL without an identity code) and, thus, the affiliate would not receive a commission. In such a scenario, the gift purchaser would click on a link that goes directly to the merchant's site, bypassing the affiliate network's site and, therefore, missing the tracking information that would result in a commission for the affiliate. One solution to this problem includes having the affiliate supply both the merchant link (that the gift registry creator uses to visit the merchant), along with the affiliate link that the gift purchaser uses to visit the merchant. Thus, the purchase occurs during a visit that is initiated by an affiliate link, thereby generating commissions. However, there are complications in implementing such a technique.

As discussed below, the most basic complication is that many merchants do not offer their affiliates the opportunity to link to individual products (or do not offer links to the specific products listed by the gift registry creator). Thus, the gift registry Web site operator (affiliate) cannot create the appropriate affiliate links to specific individual products, so merchant URLs are used instead. In other words, if a gift registry creator wishes to register for a particular toaster at merchant.com, the affiliate cannot create the appropriate link that would result in a commission.

Further, merchants that do offer links to individual products may require that the links be generated via an affiliate network system. The reason for this limitation results from the burden on the merchant to manually enter individual affiliate product links into its servers and the affiliate network's servers for accurate processing when activated by a consumer. Thus, the merchant relies on the affiliate network to initiate the processing when an individual product link is created by an affiliate. In such a case, affiliates are generally warned that the individual product links they are creating will not be “active” for an hour or more while the servers are updated. Note that if a consumer clicks on a link that has not been activated yet, he or she will be taken to the affiliate network site, as with a normal affiliate network link. However, when the affiliate network attempts to locate the link in its database (for the purpose of retrieving the associated merchant URL to redirect the customer to) it will not be found. This is because the process of “activation” includes entering the affiliate link and the associated merchant URL into the affiliate network's database. Therefore, the affiliate network will not be able to redirect the customer to the appropriate URL on the merchant's site since it will not be able to locate the appropriate URL—and the link will not work. Therefore, in this case, if the affiliate does not use the affiliate network to create the link, the link will not work. As is obvious, the process of manually creating individual affiliate product links through the affiliate network's system is extremely time-consuming. For example, each link that is created may require logging into the affiliate network's service, selecting the appropriate merchant account, selecting a link creation screen, navigating through the merchant's site to locate the item referenced by the gift registry creator, copying the URL from the link creation screen, generating the affiliate link, copying the affiliate link, entering the affiliate link into the affiliate's system, and modifying the affiliate link to include supplemental tracking information. Thus, this option is not feasible for an affiliate, such as a gift registry, once even a small number of gift registry creators start shopping at a particular online merchant.

Note that some affiliate networks require affiliates to generate individual product links through the affiliate network to ensure that the affiliates do not make mistakes while copying and installing the individual product links. In such cases, if the affiliate can automate the process of creating individual product links, it may satisfy the requirements of the affiliate networks, while processing the affiliate links rapidly enough to provide adequate functionality. However, it may be impossible to generate the appropriate affiliate link from a merchant URL if the affiliate link contains information that is not contained in the merchant URL and, therefore, is not available to the affiliate. An example of such an individual product link for a merchant and the corresponding affiliate network link is shown below:

Individual Product URL at merchant.com:

http://www.merchant.com/cgi-bin/bv.cgi?BV_EngineID=daljj gdfeghbedbfickcme.1&BV_Operation=Dyn_A ppdRecv&BV_SessionID=1739859157&form%25destination_type=template &BV_ServiceName=merchant&form%25destination=%2ftemplates%2fOutpo st%2fproduct%2fproduct_detail.tmpl&form%25bv_content_content_oid=367 82

Corresponding Affiliate Network Individual Product Code:

<a href=“http://click.affiliate-network.com/fs-bin/click?id=G1htY0Jnve0&offerid=2161.11014320&type=10&subid=”>Ga me Name 4

</a><img alt=“icon” width=“1” height=“1” src=“http://ad.affiliate-network.com/fs-bin/show?id=G1htY0Jnve0&bids=2161.11014320&type=10&subid=”>

In the above example, the affiliate link uses the identity code 2161.11014320, where 2161 is the merchant identifier (for merchant.com) and 11014320 is the product identifier (e.g., Game Name 4). Note that these numbers are not found within the individual product URL at merchant.com. Consequently, the affiliate link cannot be created using only the information contained in the individual product URL at merchant.com. Thus, the affiliate link must be created through the affiliate network's system and, as discussed, is prohibitively time-consuming.

An embodiment for generating a commission link, which links to an individual product on a merchant's Web site while obtaining credit towards a commission, will now be discussed. In general, one embodiment includes showing a consumer at an affiliate's site (e.g., gift purchaser at Swagbag.com) a sequence of two URLs when an affiliate link (e.g., textual link on swagbag.com) is selected. For example, a person may make a “wish” list of items that he or she would like to receive for Christmas, as an aid to family members. This person could go to the affiliate site called Swagbag.com and create a user account. He or she could then create a Christmas Wish List associated with the user account. This Christmas Wish List may be a web page accessible via Swagbag.com that has an associated user name and optional password. The person (now a “customer” of Swagbag.com) could then install a special button (called the Stasher) on his or her web browser that links to Swagbag.com. Once this is complete, the customer could then type a URL into the address line of their browser, where the URL corresponds to the web site of a particular merchant. Next, the customer might find a specific product that he or she would like to receive as a gift. The customer would then click the Stasher button, which would record the specific URL of the product onto the customer's Christmas Wish List, along with associated information such as a description and price. Once the customer has completed his or her Christmas Wish List, he or she would tell family members about the list so that they could use it to purchase items for the customer for Christmas. In this case, the family member would go to Swagbag.com, click “Guest Login” and enter the name and, if applicable, associated password for the customer's Christmas Wish List. This family member would then see the list of items on the Christmas Wish List, along with the associated information. To purchase an item, the family member would click on its description. The top portion of the family member's browser would display the item information, and the bottom portion of the browser would be brought to the URL that the customer recorded for the location of the item, which would be located at the merchant's site. The family member would then complete the purchase in the bottom portion of the browser as with any other online purchase, using the top portion of the browser screen for reference. When the purchase is complete, the family member would click the “back” button on the browser or the “Return to Swagbag.com” icon in the top portion of the browser. This would remove the split browser screen and return the family member's browser to the Christmas Wish List, where they can mark the item as “bought” in the Christmas Wish List so another family member doesn't purchase a duplicate item.

First, the consumer may be directed to the merchant's home page, via a home page affiliate link (provided by the merchant). At this point, the merchant is able to identify the affiliate responsible for directing the consumer to its site. Then, the consumer's browser window is automatically “refreshed” with the merchant's individual product URL of the product selected by, for example, the gift registry creator. Note that the merchant treats the “refresh” as an internal site movement (e.g., movement from one page on merchant.com directly to another page on merchant.com without first leaving merchant.com), thus, the tracking information assigned to the consumer during the merchant home site visit is preserved once the consumer gets to the individual product site. This obviates the need to transform the gift registry creator's URL into an affiliate URL, which is the source of the commission generation problems previously described. In other words, first the consumer reaches the merchant's site via an affiliate link (e.g., one that is directed to the merchant's home page). Second, the consumer performs an action before leaving the merchant's site (e.g., make a purchase), thus, triggering a commission. Since the “refresh” is treated as a movement from one page to another while remaining within the affiliate's site, if the customer completes the action, a commission is triggered. As previously discussed, the consumer's action satisfying the second condition is dependent upon the affiliate program, and may be as simple as merely visiting the merchant's site via the affiliate link.

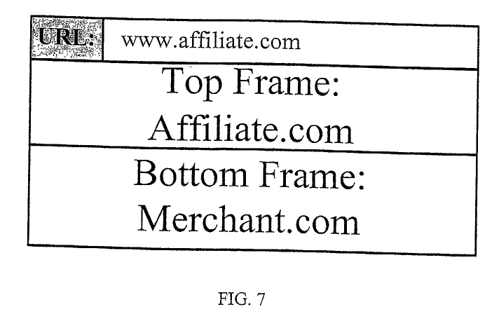

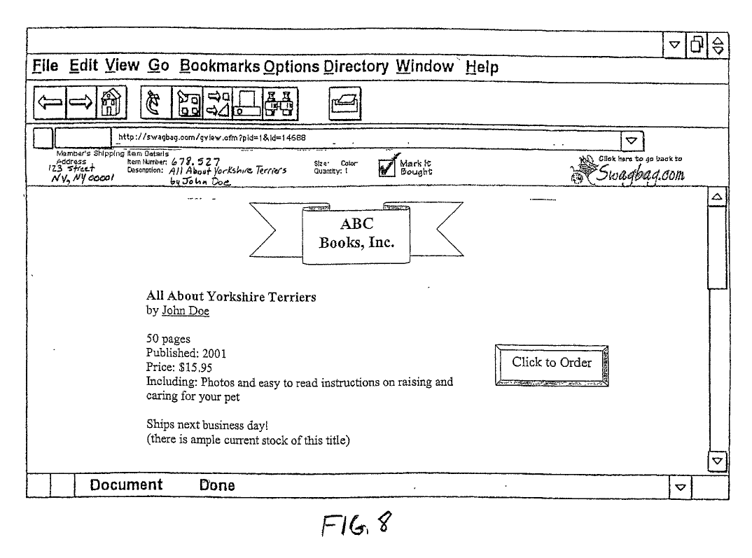

In the example of an affiliate's gift registry Web site, implementation of such an embodiment may include creating a horizontally-divided frameset when a link (e.g., link on a “wish” list) is selected. The top frame contains descriptive information of the item (e.g., gift) that has been selected, and the bottom frame contains the affiliate link to the merchant's home page. The bottom frame is refreshed automatically after a predetermined or selected period (e.g., 5 seconds) with the URL that was originally selected by the gift registry creator. Note that the predetermined or selected period is not restricted to any set period or range. In other words, the period may be set so that the consumer doesn't even realize that they have been linked to the merchant's site via the affiliate link (e.g., merchant's home page) before being redirected (via “refresh”) to the individual product link. Furthermore, the predetermined or selected period may be set such that the consumer is fully aware that he or she has been linked first to the merchant's site (e.g., home page). In such a case, the predetermined or selected period may be set to allow ample time for the consumer to see information, ads, etc. before being redirected to the individual product link. Note that the link to the individual product on the merchant's site is accomplished with the same URL the gift registry creator sees when he or she places the item on the gift registry. Therefore, all of the limitations imposed by the creation of individual affiliate product links are eliminated. FIG. 7 illustrates the structure of a horizontally-divided frameset, and FIG. 8 illustrates such a frameset in use with an exemplary gift registry item. Referring to FIG. 7, the top area represents the browser's address line, and it shows a URL located at www.affiliate.com, the affiliate's Web site (e.g., swagbag.com). The middle area represents an area located within the browser window that displays content supplied by the affiliate.com Web site. The bottom area represents an area located within the browser window that displays content supplied by the merchant.com site referenced by the product link. The affiliate.com Web site dictates the contents of each frame, and the contents of the frames may be changed remotely by the affiliate.com Web site, even though the contents of the bottom frame are being supplied by another Web site. The affiliate.com Web site maintains control over the browser for any frameset.

The embodiments described herein work very well in the case of a gift registry Web site. However, the embodiments may also be applied to non-gift-registry situations. For example, the operator of a cooking advice Web site may offer links to specific cooking products. In the past, the cooking advice Web site may not have had the ability to do this because such specific cooking product links may not have been offered to affiliates (as explained previously). Thus, these embodiments allow any Web site operator to create affiliate links to individual products on a merchant's Web site and, therefore obtain credit towards a commission from the merchant.

Further, the embodiments described above may apply to merchant-run affiliate programs. The structure and contents of the frameset are the same as with affiliate networks, except that a consumer clicking on a product link is taken directly to the merchant's site in the bottom portion of the frameset rather than to the affiliate network's site and then the merchant's site in the bottom portion of the frameset. Also, note that the URL examples included herein are merely illustrative and not intended to limit the scope of the disclosure. Even further, the embodiments described herein referencing the “Web” are merely illustrative and, as discussed below, are not intended to limit the scope of the disclosure.

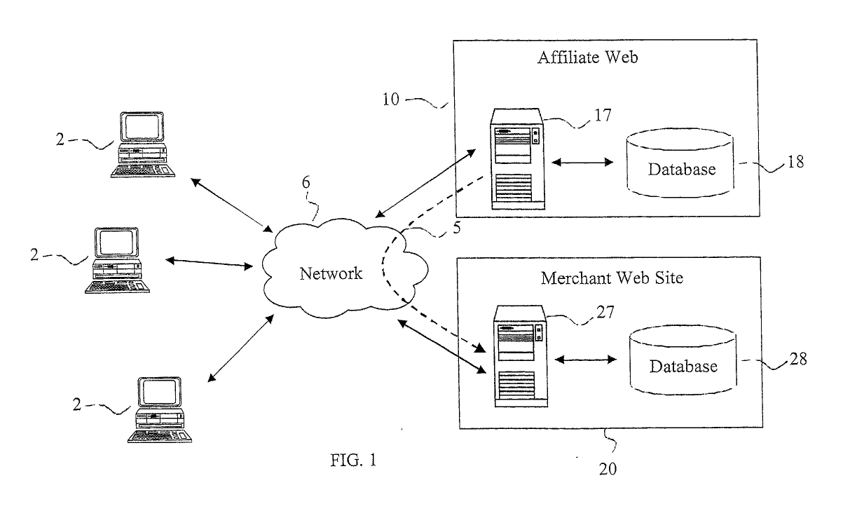

FIG. 1 is a block diagram of an exemplary system for generating a commission in a merchant-administered affiliate program. The system includes one or more consumer systems 2 coupled to an affiliate Web site 10 via a network 6. Each consumer system 2 may be implemented using a general-purpose computer executing a computer program for carrying out the processes described herein. The network 6 may be any type of known network including a local area network (LAN), wide area network (WAN), global network (e.g., Internet), intranet, extranet, etc. The consumer systems 2 may be coupled to the affiliate Web site 10 through multiple networks (e.g., intranet and/or Internet) so that not all consumer systems 2 are coupled to the affiliate Web site 10 via the same network. One or both of the consumer systems 2 and the affiliate Web site 10 may be connected to the network 6 in a wireless fashion and network 6 may be a wireless network. In one embodiment, the network 6 is the Internet and consumer system 2 executes a user interface application (e.g., Web browser) to contact the affiliate Web site 10 through the network 6. Alternatively, a consumer system 2 may be implemented using a device programmed primarily for accessing network 6 such as WebTV or a network computer.

The affiliate Web site 10 includes a processor, such as a server 17 operating in response to a computer program stored in a storage medium accessible by the server. The server 17 may operate as a network server (often referred to as a Web server) to communicate with the consumer systems 2. The server 17 handles sending and receiving information to and from consumer systems 2 and can perform associated tasks. The server 17 may also include a firewall to prevent unauthorized access to affiliate Web site 10 and enforce any limitations on authorized access. The firewall may be implemented using conventional hardware and/or software as is known in the art.

The server 17 may also operate as an applications server. In other words, the server 17 may execute one or more computer programs to interact with a database 18. It is understood that separate servers may be used to implement the network server functions and the applications server functions. Alternatively, the network server, firewall and the applications server may be implemented by a single server executing computer programs to perform the requisite functions.

Database 18 contains a variety of information related to an affiliate. In one embodiment, the host system 10 is operated by an affiliate network and the database 18 includes information concerning tracking and crediting commissions to affiliate accounts. The database 18 may be contained in a legacy, mainframe system also maintained by the affiliate network. Server 17 may interact with database 18 through existing legacy components. Changes to database 18 can be made dynamically, in real time to instantaneously update information contained in the database 18. Thus, credit to an affiliate's account for a commission may be processed immediately by server 17 without human intervention. Of course, other embodiments may include the host system 10 being operated by a merchant and/or the database 18 being maintained by the merchant.

The affiliate Web site 10 may contain one or more links 5 to other Web sites. In one embodiment, one or more links 5 may be to a merchant Web site 20. In the embodiment of FIG. 1, link 5 may be a specialized “affiliate link,” containing identity codes that identify the consumer system 2 to the merchant Web site 20 as a “referral” of the affiliate Web site 10. The link 5 may point to the main Web page of the merchant Web site 20 or, the link 5 may point to other pages within the merchant Web site 20.

The merchant Web site 20 may include a server 27 interacting with a database 28. As with the affiliate Web site 10, the merchant Web site 20 includes a processor, such as a server 27, operating in response to a computer program stored in a storage medium accessible by the server 27. The server 27 may execute one or more computer programs to interact with a database 28.

The database 28 contains a variety of information related to a merchant. In one embodiment, the merchant Web site 20 is operated by a merchant in the business of selling items. In such an embodiment, the database 28 includes information concerning items for sale and information concerning tracking and crediting commissions to affiliate accounts. Alternatively, the merchant Web site 20 may be operated for purposes other than sales. In such an embodiment, the database 28 may include information regarding the merchant's business in addition to information concerning tracking and crediting commissions to affiliate accounts.

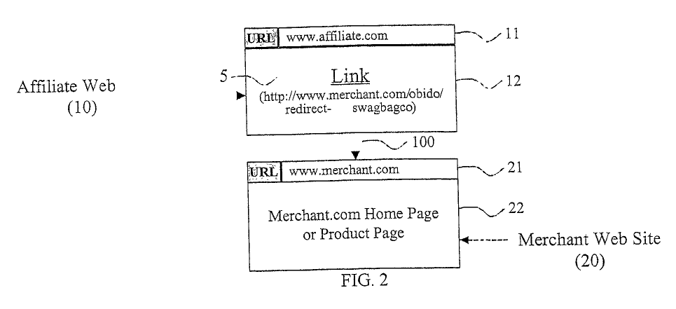

Referring to FIG. 2, operation of the system illustrated in FIG. 1 (from the consumer's perspective) will now be described. As discussed, the consumer system 2 may include a user interface application (e.g., a Web browser), which connects to the server 17 via the network 6. This Web browser may contain an address line 11 and a content display area 12. When the Web browser is pointing to the affiliate Web site 10, the address line 11 will contain a URL from the domain associated with the affiliate Web site 10 (e.g. affiliate.com). The content display area 12 may contain one or more links 5 to the merchant Web site 20. The links 5 in the content display area 12 may be supplied by the affiliate Web site 10 and, thus, the affiliate Web site 10 may control what is displayed.

When the consumer performs an action 100, the Web browser may be directed to the merchant Web site 20. In one embodiment, the action 100 may be the process of executing the link 5. Following execution of the action 100, the address line 21 may contain a URL from the domain associated with merchant Web site 20 (e.g. merchant.com). A content display area 22 may contain information supplied by the merchant Web site 20, and the merchant Web site 20 may control what is displayed. Once the action 100 has been executed, the consumer may perform one or more acts that would result in a commission payment from the merchant site 20 to the affiliate site 10. Such acts may include, but are not limited to, purchasing a product, purchasing a service, participating in a survey, or requesting additional information from the merchant Web site 20.

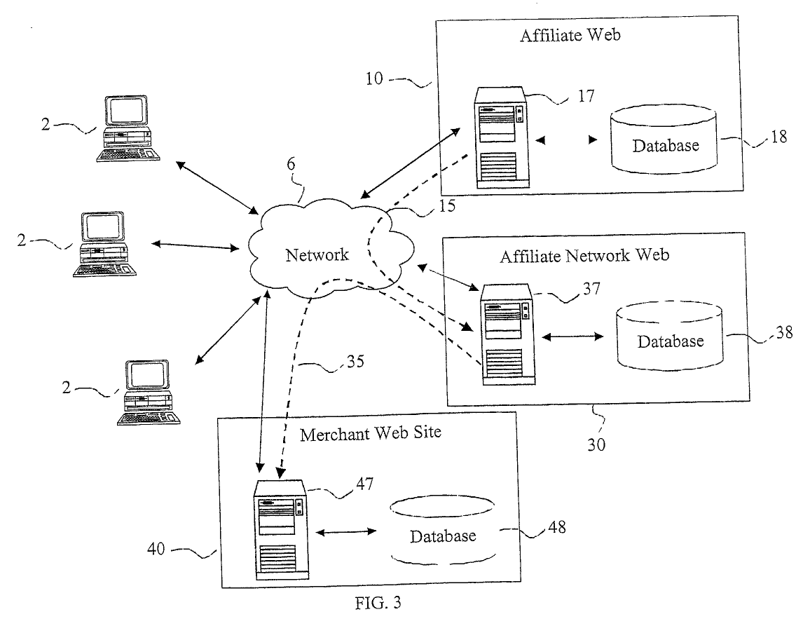

FIG. 3 is a block diagram of an exemplary system for generating a commission in a third-party-administered affiliate program. Similar to the system of FIG. 1, the system of FIG. 3 includes one or more consumer systems 2 coupled to an affiliate Web site 10 via a network 6. In one embodiment, the network 6 is the Internet and consumer system 2 executes a user interface application (e.g., Web browser) to contact the affiliate Web site 10 through the network 6. The affiliate Web site 10 includes a processor, such as a server 17, operating in response to a computer program stored in a storage medium accessible by the server 17. The server 17 may execute one or more computer programs to interact with a database 18.

An affiliate network Web site 30 includes a processor, such as a server 37, operating in response to a computer program stored in a storage medium accessible by the server 37. The server 37 may execute one or more computer programs to interact with a database 38. The database 38 contains a variety of information related to an affiliate. In one embodiment, the affiliate network Web site 30 may be operated by an affiliate network. In such an embodiment, the database 38 includes information concerning tracking and crediting commissions to affiliate accounts and information concerning processing of identity codes such as those contained in links 15. The database 38 may be contained in a legacy, mainframe system also maintained by the affiliate network. The server 37 may interact with the database 38 through existing legacy components. Changes to the database 38 may be made dynamically, in real time to instantaneously update information contained in the database 38. Thus, credit to an affiliate's account for a commission may be processed immediately by the server 37 without human intervention.

The affiliate Web site 10 may contain one or more links 15 to other Web sites. In one embodiment, one or more links 15 may be to the affiliate network Web site 30. In the embodiment of FIG. 3, link 15 may be a specialized “affiliate link,” containing identity codes that identify the consumer system 2 to the affiliate network Web site 30 as a “referral” of the affiliate Web site 10, and also containing other identity codes to indicate the ultimate destination of the Web browser on a merchant Web site 40. When the consumer system 2 activates a link 15, the Web browser may be directed to the affiliate network Web site 30. The server 37 may query the database 38 for a corresponding link 35 to activate, and may automatically activate link 35 (immediately directing the consumer system 2 to the merchant Web site 40, without human intervention). The link 35 may also be a specialized “affiliate link,” containing identity codes that identify the consumer system 2 to the merchant Web site 40 as a “referral” of the affiliate Web site 10 (that had passed through the affiliate network Web site 30 before arriving at the merchant Web site 40). The link 35 may point to the main home page of the merchant Web site 40 or to other pages within the merchant Web site 40. The specific destination of link 35 may be dictated by the contents of the link 15, as determined by the operator of the affiliate Web site 10 when the link 15 is created.

The merchant Web site 40 is comprised of a server 47 interacting with a database 48. As with the merchant Web site 20 described in FIG. 1, the merchant Web site 40 includes a processor, such as a server 47 operating in response to a computer program stored in a storage medium accessible by the server. The server 47 may execute one or more computer programs to interact with the database 48.

The database 48 contains a variety of information related to a merchant. In one embodiment, the merchant Web site 40 is operated by a merchant in the business of selling items. In such an embodiment, the database 48 includes information concerning items for sale and information concerning tracking and crediting commissions to affiliate accounts. Alternatively, the merchant Web site 40 may be operated for purposes other than sales. In such an embodiment, the database 48 may include information regarding the merchant's business in addition to information concerning tracking and crediting commissions to affiliate accounts.

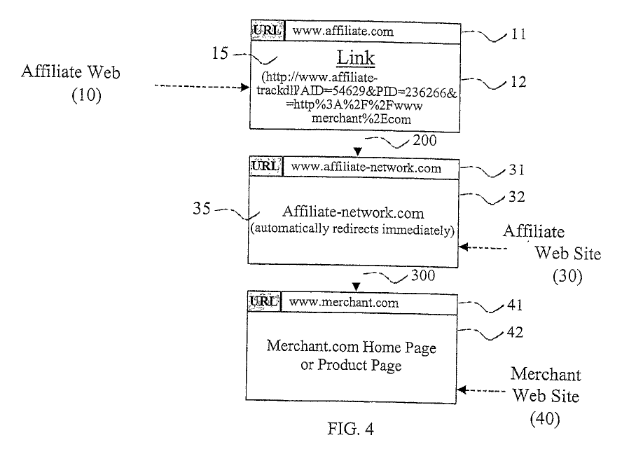

Referring to FIG. 4, operation of the system illustrated in FIG. 3 (from the consumer's perspective) will now be described. As discussed, the consumer system 2 may include a user interface application (e.g., a Web browser), which connects to server 17 via network 6. This Web browser may contain an address line 11 and a content display area 12. When the Web browser is pointing to affiliate Web site 10, the address line 11 will contain a URL from the domain associated with affiliate Web site 10 (e.g. affiliate.com). The content display area 12 may contain one or more links 15 to an affiliate network Web site 30. All of the contents of the content display area 12 may be supplied by the affiliate Web site 10, and the affiliate Web site 10 may control what is displayed.

When the consumer performs an action 200, the Web browser may be directed to the affiliate network Web site 30. In one embodiment, action 200 may be the process of executing link 15. Following execution of the action 200, the address line 31 may contain a URL from the domain associated with affiliate network Web site 30 (e.g. affiliate-network.com). A content display area 32 may contain information supplied by the affiliate network Web site 30, and the affiliate network Web site 30 may control what is displayed. In one embodiment, the affiliate network Web site 30 may not choose to display anything in the content display area 32, preferring instead to leave the area blank.

When the consumer system 2 accesses the affiliate network Web site 30, the affiliate network Web site 30 may immediately and automatically execute action 300. In one embodiment, action 300 may be the process of redirecting the Web browser operated by the consumer system 2 from the affiliate network Web site 30 to the merchant Web site 40 using the link 35. When this occurs, the address line 41 may contain a URL from the domain associated with merchant Web site 40 (e.g. merchant.com). The content display area 42 may contain information supplied by the merchant Web site 40, and the merchant Web site 40 may control what is displayed. Once action 300 has been executed, if the user performs an action on the merchant site 40 that generates a commission payment (as described in the explanation of FIG. 2), then that action may also generate a commission payment, provided that the link 15 contains the appropriate affiliate identity codes.

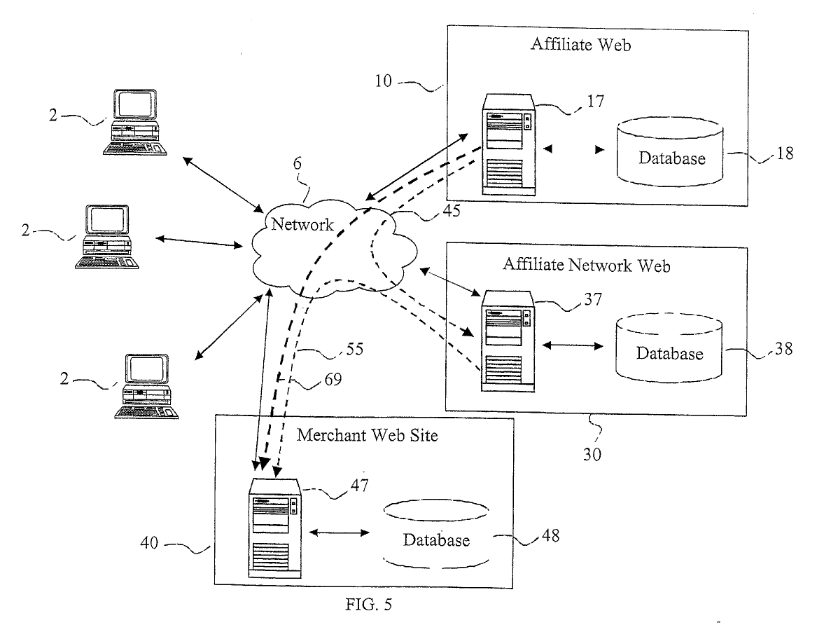

FIG. 5 is a block diagram of an exemplary system for generating a commission in a third-party-administered affiliate program in another embodiment of the invention. The Affiliate Web site 10, affiliate network Web site 30, and merchant Web site 40 operate as they do in the embodiment of FIG. 3. However, the links between the Web sites differ from the embodiment of FIG. 3. In such an embodiment, the affiliate Web site 10 may contain one or more links 45 to the affiliate network Web site 30. However, the link 45 is not a typical link, such as a hyperlink. When activated, the link 45 may execute a series of actions. First, a frameset may be launched within the Web browser of the consumer system 2. In one embodiment, this frameset contains two frames arranged in a configuration having one frame above the other frame (in the Web browser). The top frame may display content supplied by the affiliate Web site 10. The bottom frame is directed to the affiliate network Web site 30 in the same manner the link 15 was executed in FIG. 3. In such an embodiment, the link 45 may be a specialized “affiliate link,” containing identity codes that identify the consumer system 2 to the affiliate network Web site 30 as a “referral” of the affiliate Web site 10. Additionally, the link 45 may contain other codes that indicate that the ultimate destination of the link is the main home page on the merchant Web site 40.

When the consumer system 2 activates the link 45, the bottom frame of the Web browser may be directed to the affiliate network Web site 30. The server 37 may query the database 38 for activating a corresponding link, and then automatically activate the link 55. This redirects the consumer system 2 to the merchant Web site 40 (without human intervention). In such an embodiment, the link 55 may be a specialized “affiliate link,” containing identity codes that identify the consumer system 2 to the merchant Web site 40 as a “referral” of the affiliate Web site 10 that had passed through affiliate network Web site 30 before arriving at merchant Web site 40. In one embodiment, the link 55 may always direct the consumer system's 2 Web browser to the main home page of the merchant Web site 40. In such an embodiment, the top frame of the consumer system's 2 Web browser may continue to display information from the affiliate Web site 10, and the bottom frame of the Web browser may display information from the merchant Web site 40. The affiliate Web site 10 may continue to control the action of the frameset, even though some of the contents may be supplied by the merchant Web site 40.

After a predetermined or selected period, the affiliate Web site 10 causes the bottom frame of the consumer system's 2 Web browser to redirect to a different Web page within the merchant Web site 20 using the link 69. In one embodiment, the link 69 may be a normal hyperlink without any affiliate identity codes. The destination of the link 69 may be supplied by the operator of the affiliate Web site 10, a user of the affiliate Web site 10, or a third party. Note that the link 69 does not reference the affiliate network site 30, but instead causes the bottom frame of the consumer system's 2 Web browser to move from one Web page on the merchant Web site 40 to another Web page on the merchant Web site 40.

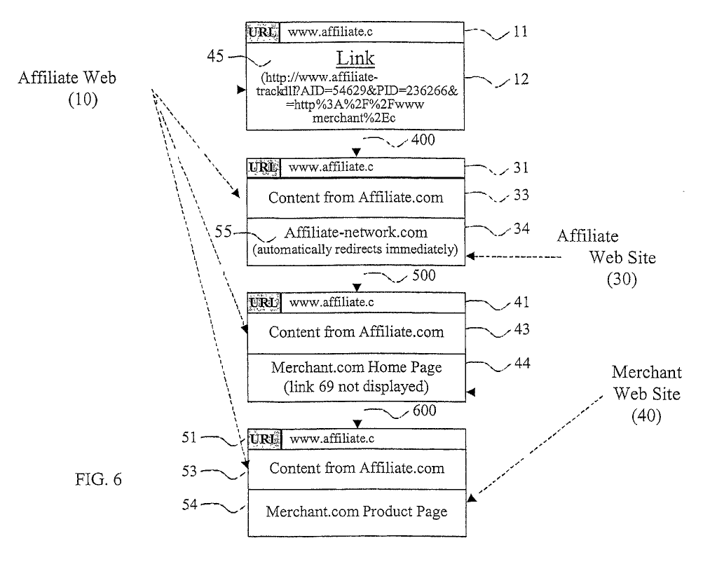

Referring to FIG. 6, operation of the system illustrated in FIG. 5 (from the consumer's perspective) will now be described. As discussed, the consumer system 2 may include a user interface application (e.g., a Web browser), which connects to server 17 via network 6. This Web browser may contain an address line 11 and a content display area 12. When the Web browser is pointing to affiliate Web site 10, the address line 11 will contain a URL from the domain associated with affiliate Web site 10 (e.g., affiliate.com). The content display area 12 may contain one or more links 45 to an affiliate network Web site 30. All of the contents of the content display area 12 may be supplied by the affiliate Web site 10, and the affiliate Web site 10 may control what is displayed.

When the consumer performs an action 400, the consumer's Web browser may be directed to the affiliate network Web site 30. In one embodiment, action 400 may be the process of executing link 45. Following execution of action 400, the content display area 12 may be split into a frameset including a top frame 33 and a bottom frame 34. The top frame 33 may display content supplied from the affiliate Web site 10. The bottom frame 34 may contain information supplied by the affiliate network Web site 30, and the affiliate network Web site 30 may control what is displayed in the frame 34. However, the affiliate Web site 10 may retain control of the overall frameset. Accordingly, the address line 31 may contain a URL from the domain associated with affiliate Web site 10 (e.g., affiliate.com). In one embodiment, the affiliate network Web site 30 may not choose to display anything in the bottom frame 34, preferring instead to leave the area blank.

When the consumer system 2 accesses the affiliate network Web site 30 via the bottom frame 34, the affiliate network Web site 30 may immediately and automatically execute action 500. In other words, the consumer system 2 accesses the affiliate network Web site 30 via selecting a link on the affiliate Web site 10, which points to the affiliate network Web site 30. Once the consumer's browser arrives at the affiliate network Web site 30, the affiliate network may immediately and automatically redirect the browser to the merchant Web site 40. Note that this process may be invisible to the consumer because the consumer may think that he or she is going directly from the affiliate's Web site 10 to the merchant's Web site 40. In one embodiment, the action 500 is the process of redirecting the bottom frame 34 of the Web browser (operated by the consumer system 2) from the affiliate network Web site 30 to the merchant Web site 40 using the link 55. When this occurs, the address line 41 may continue to display a URL from the domain associated with the affiliate Web site 10. The top frame 43 may continue to display content supplied from the affiliate Web site 10. The bottom frame 44 may contain information supplied by the merchant Web site 40, and the merchant Web site 40 may control what is displayed in this frame. However, the affiliate Web site 10 may still retain control of the overall frameset.

After a predetermined or selected period, the affiliate Web site 10 may automatically execute action 600. In one embodiment, the action 600 may be the process of redirecting the bottom frame 44 of the Web browser (operated by consumer system 2) from one Web page on the merchant Web site 40 to a different Web page on the merchant Web site 40 using link 69. When this occurs, the address line 51 may continue to display a URL from the domain associated with the affiliate Web site 10. The top frame 53 may continue to display content supplied from the affiliate Web site 10. The bottom frame 54 may contain information supplied by the merchant Web site 40, and the merchant Web site 40 may control what is displayed in this frame. However, the affiliate Web site 10 may still retain control of the overall frameset. Once action 600 has been executed, if the user performs an action on the merchant site 40 that generates a commission payment (as described in the explanation of FIG. 2), then that action may also generate a commission payment. Thus, the embodiments described herein allow for generating a commission payment not previously attainable in many situations.

In another embodiment, action 400 may connect the Web browser of the consumer system 2 directly to the merchant Web site 40 instead of to the affiliate network Web site 30. In such an embodiment, following execution of the action 400, the content display area 12 may be split into a frameset consisting of top frame 43 and bottom frame 44. The top frame 43 may display content supplied from the affiliate Web site 10. The bottom frame 44 may contain information supplied by the merchant Web site 40, and the merchant Web site 40 may control what is displayed in this frame. However, the affiliate Web site 10 may still retain control of the overall frameset.

Again, after a predetermined or selected period, the affiliate Web site 10 may automatically execute action 600. In one embodiment, the action 600 may be the process of redirecting the bottom frame 44 of the Web browser (operated by consumer system 2) from one Web page on the merchant Web site 40 to a different Web page on the merchant Web site 40 using link 69. When this occurs, the address line 51 may continue to display a URL from the domain associated with the affiliate web site. The top frame 53 may continue to display content supplied from the affiliate Web site 10. The bottom frame 54 may contain information supplied by the merchant Web site 40, and the merchant Web site 40 may control what is displayed in this frame. However, the affiliate Web site 10 may still retain control of the overall frameset. Once action 600 has been executed, if the user performs an action on the merchant site 40 that generates a commission payment (as described in the explanation of FIG. 2), then that action may also generate a commission payment. Again, the embodiments described herein allow for generating a commission payment not previously attainable in many situations.

The following Javascript® code illustrates one embodiment for program code where the consumer is using Netscape Navigator® version 4 with Mac®OS version 9 and a selected refresh delay of 5 seconds.

<SCRIPT language=“JavaScript”>

<!--

setTimeout(“urlframe.location=UNTRANSFORMED URLFORPRODUCT PAGE”, 5000);

//-->

</SCRIPT>

<frameset>
<frame name=“topframe” scrolling=“no” noresize target=“contents” src=“URL
CONTAINING PRODUCT DESCRIPTION” marginwidth=“0” marginheight=“0”>
<frame name=“urlframe” scrolling=“yes” noresize target=“contents”
src= “AFFILIATE LINK TO MERCHANT HOME PAGE” marginwidth=“0”
marginheight=“0”>
</frameset>
Note: This can also be accomplished using the command frame.location.replace in
place of the command urlframe.location.
<META http-equiv=“Content-Type” content=“text/html; charset=iso-8859-1”>
<script language=“javascript”>
<!--

function push_stash_url( ) {

| // | gvmerchant.location.replace(“UNTRANSFORMED URL FOR PRODUCT PAGE”); |
|---|---|
| | gvmerchant.location = “UNTRANSFORMED URL FOR PRODUCT PAGE”; |

}

setTimeout(’push_stash_url( )’, 5000);
// -->
</script>
</HEAD>
<FRAMESET rows=“70,1*” cols=“*” frameborder=“NO” border=“0”
framespacing=“0”>
<FRAME src=“gvtop.cfm?id=15171”name=“gvtop” noresize scrolling=“NO”
frameborder=“NO” marginwidth=“5” marginheight=“1”>
<FRAME src=“AFFILIATE LINK TO MERCHANT HOME PAGE”
name=“gvmerchant” frameborder=“NO”>

</FRAMESET>

The description applying the above embodiments is merely illustrative. As described above, embodiments in the form of computer-implemented processes and apparatuses for practicing those processes may be included. Also included may be embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a data signal transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A system for generating a commission link in a computer network, the system comprising:
an affiliate host system for presenting a user with a link to a first location having a corresponding coded link to a second location, receiving an input based on said user's selection of said link to said first location, connecting said user to said second location, connecting said user to said first location after a selected period at said second location and receiving a commission based on said connecting said user to said second location;
a network coupled to said affiliate host system; and
an affiliate database couple to said affiliate host system.

2. The system of claim 1, further including:
a user system coupled to said network; and
said user system accessing said affiliate host system via said network.

3. The system of claim 1, further including:
a merchant host system coupled to said network; and
said affiliate host system accessing said merchant host system via said network.

4. The system of claim 3, further including a merchant database coupled to said merchant host system.

5. The system of claim 1, further including:
an affiliate network host system coupled to said network;
a merchant host system coupled to said network;
said affiliate host system accessing said affiliate network host system via said network; and
said affiliate network host system accessing said merchant host system via said network.

6. The system of claim 5, further including:
an affiliate network database coupled to said affiliate network host system; and
a merchant database coupled to said merchant network host system.

7. The system of claim 1, wherein said coded link is received from an online merchant for identifying an affiliate directing said user to said online merchant.

8. The system of claim 7, wherein said coded link includes a Uniform Resource Locator for said online merchant's home page in combination with a code identifying said affiliate.

9. The system of claim 1, wherein said coded link is received from an affiliate network for identifying an affiliate directing said user to said online merchant.

10. The system of claim 9, wherein said coded link includes a Uniform Resource Locator for said affiliate network and said online merchant's home page in combination with a code identifying said affiliate.

11. The system of claim 7, wherein said link to said first location is an un-coded link to a page on said online merchant's site.

12. The system of claim 7, wherein said connecting said user to said second location and said connecting said user to said first location includes:
creating a frameset in said user's browser;
wherein said frameset comprises a first frame for displaying descriptive information about an item at said first location and a second frame for displaying one or more pages from said online merchant's site;
connecting said user to said online merchant's home page via said coded link; and
connecting said user to said online merchant's page containing said item after said selected period at said online merchant's home page.

13. The system of claim 12, wherein said selected period is 5 seconds.

14. The system of claim 9, wherein said connecting said user to said second location and said connecting said user to said first location includes:
creating a frameset in said user's browser;
wherein said frameset comprises a first frame for displaying descriptive information about an item at said first location and a second frame for displaying one or more pages from said online merchant's site;
connecting said user to said affiliate network's Web site and then to said online merchant's home page via said coded link; and
connecting said user to said online merchant's page containing said item after said selected period at said online merchant's home page.

15. The system of claim 14, wherein said selected period is 5 seconds.

16. A system for generating a commission link in a computer network, the system comprising:
an affiliate host system for generating a list of one or more merchant links having one or more corresponding coded links, presenting said list of one or more merchant links to a user, receiving an input based on said user's selection from said list of one or more merchant links, connecting said user to a coded link corresponding to said input connecting said user to said selection after a selected period at said coded link and receiving a commission based on said connecting said user to said coded link;
a network coupled to said affiliate host system; and
an affiliate database couple to said affiliate host system.

17. A system for generating a commission link in a computer network, the system comprising:
an affiliate host system for presenting one or more merchant links having one or more corresponding coded links to a first user, receiving one or more first inputs based on said first user's selection of said one or more merchant links, generating a merchant link list based on said one or more first inputs, presenting said merchant link list to a second user, receiving a second input based on said second user's selection from said merchant link list, connecting said second user to a coded link corresponding to said second input, connecting said second user to said second user's selection after a selected period at said coded link and receiving a commission based on said connecting said second user to said coded link;
a network coupled to said affiliate host system; and
an affiliate database couple to said affiliate host system.

18. A method for generating a commission link in a computer network, the method comprising:
presenting a user with a link to a first location having a corresponding coded link to a second location;
receiving an input based on said user's selection of said link to said first location;
connecting said user to said second location;
connecting said user to said first location after a selected period at said second location; and
receiving a commission based on said connecting said user to said second location.

19. The method of claim 18, wherein said coded link is received from an online merchant for identifying an affiliate directing said user to said online merchant.

20. The method of claim 19, wherein said coded link includes a Uniform Resource Locator for said online merchant's home page in combination with a code identifying said affiliate.

21. The method of claim 18, wherein said coded link is received from an affiliate network for identifying an affiliate directing said user to said online merchant.

22. The method of claim 21, wherein said coded link includes a Uniform Resource Locator for said affiliate network and said online merchant's home page in combination with a code identifying said affiliate.

23. The method of claim 19, wherein said link to said first location is an un-coded link to a page on said online merchant's site.

24. The method of claim 19, wherein said connecting said user to said second location and said connecting said user to said first location includes:
creating a frameset in said user's browser;
wherein said frameset comprises a first frame for displaying descriptive information about an item at said first location and a second frame for displaying one or more pages from said online merchant's site;
connecting said user to said online merchant's home page via said coded link; and
connecting said user to said online merchant's page containing said item after said selected period at said online merchant's home page.

25. The method of claim 24, wherein said selected period is 5 seconds.

26. The method of claim 21, wherein said connecting said user to said second location and said connecting said user to said first location includes:
creating a frameset in said user's browser;
wherein said frameset comprises a first frame for displaying descriptive information about an item at said first location and a second frame for displaying one or more pages from said online merchant's site;
connecting said user to said affiliate network's Web site and then to said online merchant's home page via said coded link; and
connecting said user to said online merchant's page containing said item after said selected period at said online merchant's home page.

27. The method of claim 26, wherein said selected period is 5 seconds.

28. A method for generating a commission link in a computer network, the method comprising:
generating a list of one or more merchant links having one or more corresponding coded links;
presenting said list of one or more merchant links to a user;
receiving an input based on said user's selection from said list of one or more merchant links;
connecting said user to a coded link corresponding to said input;
connecting said user to said selection after a selected period at said coded link; and
receiving a commission based on said connecting said user to said coded link.

29. A method for generating a commission link in a computer network, the method comprising:
presenting one or more merchant links having one or more corresponding coded links to a first user;
receiving one or more first inputs based on said first user's selection of said one or more merchant links;
generating a merchant link list based on said one or more first inputs;
presenting said merchant link list to a second user;
receiving a second input based on said second user's selection from said merchant link list;
connecting said second user to a coded link corresponding to said second input;
connecting said second user to said second user's selection after a selected period at said coded link; and
receiving a commission based on said connecting said second user to said coded link.

30. A storage medium encoded with machine-readable computer program code for generating a commission link in a computer network, the storage medium including instructions for causing a processor to implement a method comprising:
presenting a user with a link to a first location having a corresponding coded link to a second location;
receiving an input based on said user's selection of said link to said first location;
connecting said user to said second location;
connecting said user to said first location after a selected period at said second location; and
receiving a commission based on said connecting said user to said second location.

31. A storage medium encoded with machine-readable computer program code for generating a commission link in a computer network, the storage medium including instructions for causing a processor to implement a method comprising:
generating a list of one or more merchant links having one or more corresponding coded links;
presenting said list of one or more merchant links to a user;
receiving an input based on said user's selection from said list of one or more merchant links;
connecting said user to a coded link corresponding to said input;
connecting said user to said selection after a selected period at said coded link; and
receiving a commission based on said connecting said user to said coded link.

32. A storage medium encoded with machine-readable computer program code for generating a commission link in a computer network, the storage medium including instructions for causing a processor to implement a method comprising:
presenting one or more merchant links having one or more corresponding coded links to a first user;
receiving one or more first inputs based on said first user's selection of said one or more merchant links;
generating a merchant link list based on said one or more first inputs;
presenting said merchant link list to a second user;
receiving a second input based on said second user's selection from said merchant link list;
connecting said second user to a coded link corresponding to said second input;
connecting said second user to said second user's selection after a selected period at said coded link; and
receiving a commission based on said connecting said second user to said coded link.

33. A computer data signal for generating a commission link in a computer network, said computer data signal comprising code configured to cause a processor to implement a method comprising:
presenting a user with a link to a first location having a corresponding coded link to a second location;
receiving an input based on said user's selection of said link to said first location;
connecting said user to said second location;
connecting said user to said first location after a selected period at said second location; and
receiving a commission based on said connecting said user to said second location.

34. The computer data signal of claim 33, wherein said computer data signal is embodied in a carrier wave.

35. The computer data signal of claim 33, wherein said computer data signal is unmodulated.

36. A computer data signal for generating a commission link in a computer network, said computer data signal comprising code configured to cause a processor to implement a method comprising:
generating a list of one or more merchant links having one or more corresponding coded links;
presenting said list of one or more merchant links to a user;
receiving an input based on said user's selection from said list of one or more merchant links;
connecting said user to a coded link corresponding to said input;
connecting said user to said selection after a selected period at said coded link; and
receiving a commission based on said connecting said user to said coded link.

37. The computer data signal of claim 36, wherein said computer data signal is embodied in a carrier wave.

38. The computer data signal of claim 36, wherein said computer data signal is unmodulated.

39. A computer data signal for generating a commission link in a computer network, said computer data signal comprising code configured to cause a processor to implement a method comprising:
presenting one or more merchant links having one or more corresponding coded links to a first user;
receiving one or more first inputs based on said first user's selection of said one or more merchant links;
generating a merchant link list based on said one or more first inputs;
presenting said merchant link list to a second user;
receiving a second input based on said second user's selection from said merchant link list;
connecting said second user to a coded link corresponding to said second input;
connecting said second user to said second user's selection after a selected period at said coded link; and
receiving a commission based on said connecting said second user to said coded link.

40. The computer data signal of claim 39, wherein said computer data signal is embodied in a carrier wave.

41. The computer data signal of claim 39, wherein said computer data signal is unmodulated.
